(19) United States
(12) Patent Application Publication
(10) Pub. No.: US 2010/0031168 A1
(43) Pub. Date: Feb. 4, 2010

(54) Displaying Menu Options Related to Objects Included in Web Pages

(75) Inventors: Mario Loriedo, Rome (IT); Tommaso Mazzarotto, London (GB); Sandro Piccini, Rome (IT)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: Internatiional Business Machines Corporation, Armonk, NY (US)

(21) Appl. No.: 12/374,248

(22) PCT Filed: Mar. 22, 2007
(86) PCT No.: PCT/EP2007/052761

§ 371 Date: Jan. 16, 2009

(30) Foreign Application Priority Data
Jul. 18, 2006 (EP) 06117380.3

(51) Int. Cl. G06F 3/01; G06F 3/048

(52) U.S. Cl. 715/760; 715/808; 715/841

(57) ABSTRACT

A mechanism for displaying web pages to a user, receives an HTML code of the web page to be displayed, and interprets the HTML code. The mechanism interprets a computer program code embedded in the HTML code of the web page to be displayed. The embedded code includes an indication of at least one menu option to be displayed upon request of the user. Responsive to a command from the user, a pop-up menu containing the at least one menu option is displayed to the user.

### TECHNICAL FIELD

The present invention relates generally to the field of data processing and data processing systems. More particularly, the invention relates to distributed data processing and data processing systems, viz. computer networks, and more particularly to computer networks supporting HTML (Hyper Text Markup Language) and HTTP (Hyper Text Transfer Protocol), that is, computer networks that allows surfing through web pages. Specifically, the present invention concerns a method and a system for displaying to a user browsing web pages, in the form of a pop-up menu, options in respect of objects embedded thereinto.

### BACKGROUND

Surfing over the Internet, and, particularly, the World Wide Web (WWW) has become a quite common experience for users of data processing apparatuses like Personal Computers (PCs).

As generally known, the WWW includes a system of server computers (hereinafter, shortly, “WWW servers” or “web servers”) of the Internet which are adapted to manage documents in a peculiar format, known as hypertext documents or, more usually, web pages, formatted in the HTML, which is a language that supports, inside a document, links to other documents, as well as graphics, audio, and video files, and the WWW servers uses, for communication purposes, the HTTP.

Users can navigate through, i.e. “surf” over the WWW by means of so-called “web browsers”, which are client software applications intended to be installed on, and be executed by, e.g., the users' PCs (or smart phones, or other data processing apparatuses) and adapted to retrieve and display HTML documents.

Web browsers are structured according to the Graphical User Interface (GUI) model that has pervasively occupied the scene of computing in the past two decades. Using GUIs, commands and resources available to the users of a data processing apparatus are presented to them relying heavily upon visual prompts (e.g., icons, pictures), for example in the form of menus displaying lists of possible actions that can be performed. Menus may in particular be presented to the users of data processing apparatuses in the form of pop-ups, presenting lists of choices appropriate for specific objects or resources, by clicking a button (commonly, the right-side button, albeit this is merely a conventional setting that can often be modified by the user) of a pointing device like a mouse or a touchpad, after having positioned the pointer on the object or resource. This is the usual experience of the users when, for example, they navigate through their local file system: clicking the appropriate button of the mouse after having positioned the pointer on a certain object or resource, like for example a file, causes a menu to pop-up with commands corresponding to actions/operations that can be performed on the selected resource or object (e.g., deleting a file, or copying it, or moving it to another directory).

Furthermore, the pop-up menus may be context-sensitive, i.e. the list of menu options (set of choices presented to the user) may depend on the particular environment in which the resource or object resides.

It is undoubted that the friendliness of GUIs has greatly contributed to the widespread diffusion of computers.

### SUMMARY

According to one illustrative embodiment, a method is provided, for displaying web pages to a user. The method comprises receiving a web page to be displayed. The web page comprises markup language code. The method further comprises interpreting the HTML code and identifying a markup language code element embedded in the markup language code of the web page to be displayed. The markup language code element comprises an indication of at least one menu option to be displayed upon request of the user responsive to a command from the user, displaying a pop-up menu containing said at least one menu option.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features of the illustrative embodiments will be described in, or will become apparent to those of ordinary skill in the art in view of, the following detailed description of the example embodiments.

### BRIEF DESCRIPTION OF THE SEVERAL VIEWS OF THE DRAWINGS

The features and advantages of the present invention will be best understood reading the following detailed description of an embodiment thereof, provided merely by way of non-limitative example, description that will be conducted making reference to the attached drawings, wherein:

FIG. 1 schematically shows a scenario wherein aspects of the illustrative embodiments can be applied;

FIG. 2 schematically shows the generic structure of a data processing apparatus in which aspects of the illustrative embodiments can be implemented;

FIG. 3 schematically shows a partial content of a working memory of a World Wide Web server, according to an illustrative embodiment;

FIG. 4 schematically shows a partial content of the working memory of a data processing apparatus while executing a World Wide Web browser, according to an illustrative embodiment;

FIG. 5 is a schematic flowchart with the main steps of a method of embedding into web pages code adapted to enable the display of pop-up menus, according to an illustrative embodiment; and

FIG. 6 is a schematic flowchart with the main steps of a method of displaying web pages, according to an illustrative embodiment.

### DETAILED DESCRIPTION

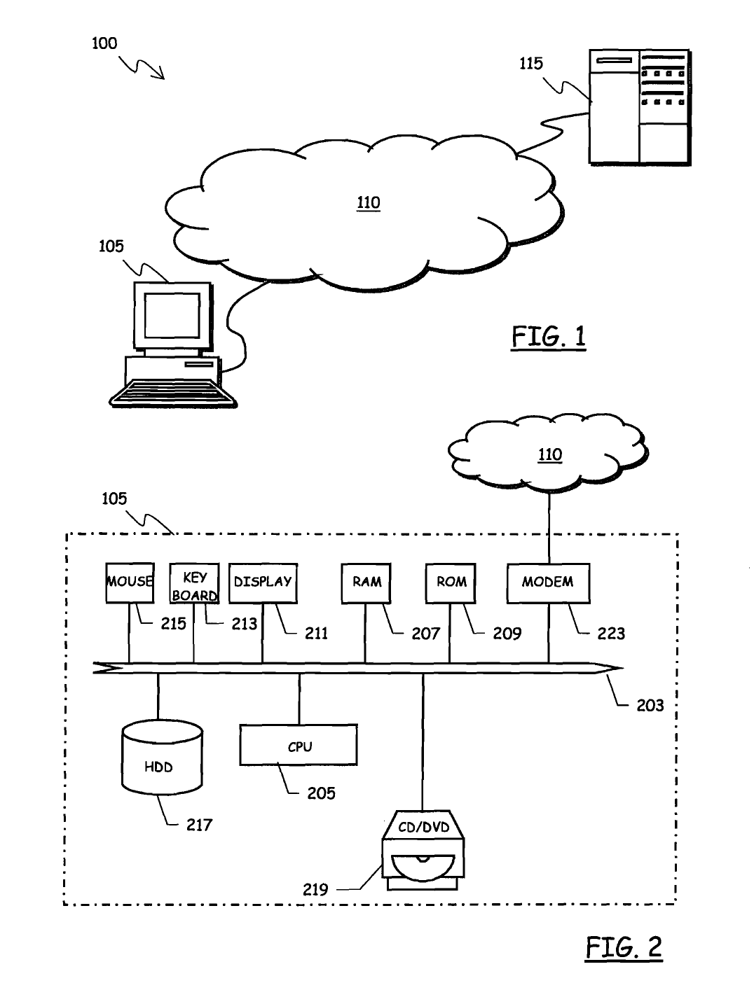

With reference to the drawings, in FIG. 1 an exemplary distributed data processing system 100 is schematically shown, comprising a client data processing apparatus 105, e.g. a PC or a smart phone, connected or connectable or, more generally, having possibility of accessing a data communications network 110, particularly but not limited to an IP (Internet Protocol) network like the Internet. Connection of the client data processing apparatus 105 to the network 110 typically takes place via an access point to the network, for example a Point Of Presence (POP) of an Internet Service Provider (ISP), not shown in the drawing. The link between the client data processing apparatus 105 and the POP may be a wired or a wireless link; a wired link may include a dial-up connection (by an analog MODEM, an ISDN MODEM or an XDSL MODEM) over the Public Switched Telephone Network (PSTN); a wireless link may include a connection to a “hot-spot” of a Wi-Fi network, or a connection through a mobile telephony network (e.g., GSM/GPRS or UMTS).

Also depicted in FIG. 1 is a web server 115, i.e. a data processing apparatus belonging to a wide sub-set of computers of the Internet that are adapted to manage HTML documents, known as web pages, and that support communications using the HTTP protocol, which defines how messages are structured and transmitted.

In FIG. 2, the structure of a generic data processing apparatus, like the client data processing apparatus 105, is schematically shown. Several functional units are connected in parallel to a data communication bus 203, for example of the PCI (Peripheral Component Interconnect) type. In particular, a Central Processing Unit (CPU) 205, typically comprising a microprocessor (the CPU may possibly comprise more than one microprocessor), controls the operation of the computer 105, a working memory 207, typically a Random Access Memory (RAM), is directly exploited by the CPU 205 for the execution of programs and for temporary storage of data, and a Read Only Memory (ROM) 209 stores a basic program for the bootstrap of the computer 105. The computer 105 comprises several peripheral units, connected to the bus 203 by means of respective interfaces. Particularly, peripheral units that allow an easy and friendly interaction with a human user are provided, such as a display device 211 (for example a CRT, an LCD or a plasma monitor), a keyboard 213 and a pointing device 215 (for example a mouse or a touchpad). The computer 105 also includes peripheral units for local mass-storage of programs and data (e.g., operating system, application programs, user files), such as a magnetic Hard-Disk Driver (HDD) 217, driving magnetic hard disks, and a CD-ROM/DVD driver 219, for reading/writing CD-ROMs/DVDs. Other peripheral units may be present, such as a floppy-disk driver for reading/writing floppy disks, a memory card reader for reading/writing memory cards and the like. The computer 105 is further equipped with a MODEM 223, for the connection to the Internet access point; where the computer 105 is part of a local computer network, e.g. a LAN, a Network Interface Adapter (NIA) card is provided, for the connection to the local computer network; instead of, or in addition to the MODEM 223, a Wi-Fi card may be provided, for connection to a hot-spot.

Any other computer in the computer network 100, for example the web server 115, has a structure generally similar to the one depicted in FIG. 2, possibly properly scaled, depending on the machine computing performance.

The web server 115 may host groups of web pages linked together by hypertext links (briefly, “hyperlinks”); such groups of web pages make up what is commonly referred to as a web site.

Web sites can be visited, and the corresponding web pages can be displayed on the display devices of the client data processing apparatuses of users, like the user of the data processing apparatus 105. In particular, in order to locate desired web pages within the WWW and display them in human-readable form on the display device 211, the user of the data processing apparatus 105 exploits a specifically-designed software application, commonly referred to as a browsing software or Web browser or, more simply, browser. Commercially-available browsers, such as the Microsoft Internet Explorer® web browser, the Netscape Navigator™ Web browser, the Mozilla Firefox® web browser, just to cite a few, which are capable of displaying web pages containing text, graphics and even additional multimedia content, such as video and sound. The browser, assumed to have been properly installed on the data processing apparatus 105, is launched by the user either explicitly or implicitly, for example clicking with a mouse button on a hypertext link.

Web pages are, as mentioned, written in HTML, a markup programming language, that is understood by the browsers running at the users' data processing apparatuses; the browsers parse the HTML code of a located and downloaded web page and accordingly display the page to the user, with text and graphics.

As discussed in the foregoing, known browsers are not able to display, e.g. in the form of a pop-up menu, options (e.g., commands, actions) related to a generic object included in a displayed web page and corresponding to a resource residing on the WWW server. This is due to the fact that, exception made for image objects, introduced in the HTML listing by the “img” tag, and anchor objects, introduced by the “a” tag, the browser, running on the user's data processing apparatus, is generally not aware of either the nature of the generic resource, nor of the action(s) that can be performed on such generic resource.

In the following, a method will be described, according to an embodiment of the present invention, that allows a browser running on the data processing apparatus, e.g. the PC of a user visiting a WWW server, for example while surfing the Internet, to display to the user, e.g. upon clicking a mouse or other pointer device button, a pop-up menu with options, e.g. commands, actions that can be performed on a generic object embedded in the web page being displayed.

According to an illustrative embodiment, a custom-defined HTML tag may be exploited, which is included into the HTML code of the web page, e.g. in association with a certain, generic object or resource embedded in the web page and resident on the WWW server, so as to introduce a portion of custom-designed software code (the specific code language used is per-se not limitative: it may for example be non-standard, custom-defined HTML code) adapted to specify one or more menu options corresponding to actions that the user of the client PC can perform on that object or resource.

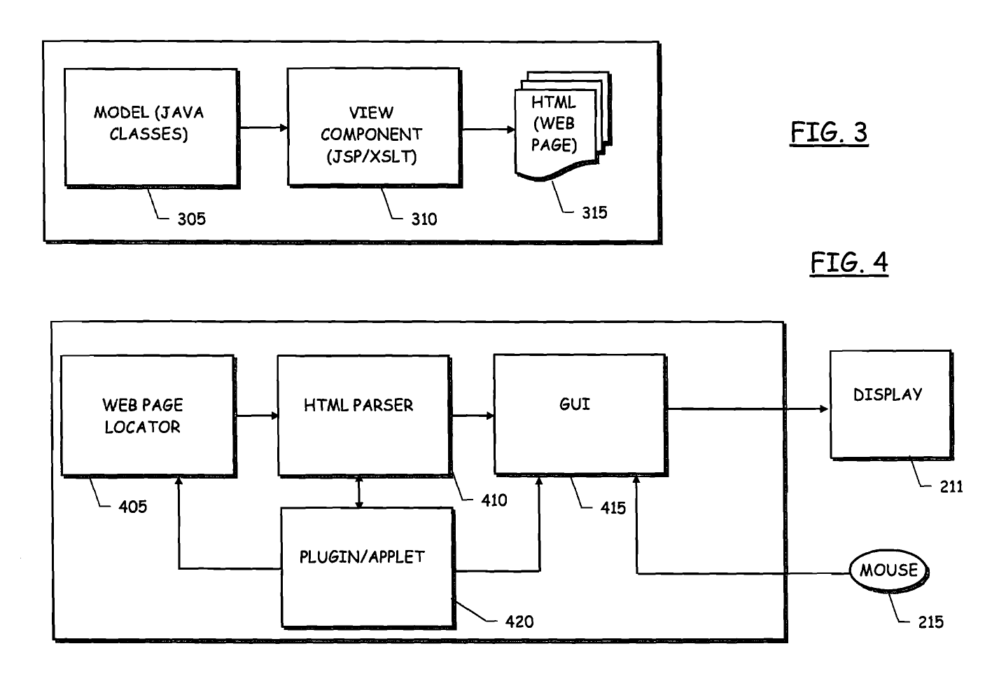

Reference is made to FIG. 3, showing, in terms of functional blocks, components (including software components) that are used to create a custom-designed code to be embedded into a web page published on a WWW server, in respect of a generic object/resource included in the web page, so as to specify one or more menu options that the browser can interpret and display to the user, for example in the form of a pop-up menu, e.g. upon clicking of a mouse or other pointer device button. It is pointed out that the generation of the HTML code for the web pages, and, in particular, of the custom-designed code to be embedded therein for the rendering, on the client side, of the menu, may, but not necessarily has to be performed at the WWW server: the web pages may be generated, e.g. by a web page designer, at a different location than the WWW server, and then be uploaded to the WWW server for their publication; thus, the description that follows may, but not necessarily has to relate to the WWW server 115. In particular, according to an example embodiment, an MVC (Model, View, Controller) pattern is assumed to be relied upon for creating the HTML code for web pages to be published by the WWW server 115. As known to those skilled in the art, and without entering into excessive details, the MVC pattern is a software architecture that separates an application's data model, an application's user interface, and an application's control logic into three distinct components, so that modifications to one component can be made with minimal impact to the others. The model component 305 contains dynamic data, e.g. Java classes, intended to be displayed by the browser in the customized pop-up menu; such dynamic data include for example pairs of menu labels and corresponding URLs (Uniform Resource Locators), i.e. Internet addresses, being the link to Internet sites where the specific programs adapted to carry out the actions specified by the respective labels can be found. The view component 310, for example a component based on the known JSP (Java Server Pages) technology, has the responsibility of generating the HTML code 315, starting from the dynamic data (model). It is pointed out that, although the MVC pattern, and, more particularly, the Java classes model component 310 and the JSP view component 310 are often used in Web User Interface (WUI) framework, different technologies may be used; for example, instead of a JSP component, an XSL (eXtensible Stylesheet Language) template component may be used.

FIG. 4 schematically shows the main components of a browser according to an illustrative embodiment. The browser is intended to be executed by the data processing apparatus 105 of a user. A web page locator module 405 is adapted to locate, within the WWW, web pages selected by the user, and to download the respective HTML code. An HTML parser module 410 is adapted to parse the HTML code of the selected web pages. A GUI module 415 is adapted to display the selected web pages, on the PC's display deviced 211.

According to an embodiment of the present invention, a browser plug-in module 420 is further provided, which is adapted to decode custom-designed code embedded within web pages for implementing the displaying of menu options in respect of generic resources included in a downloaded web page. The plug-in module 420 interacts with the GUI module 415, so that predetermined actions of the users, like the clicking of the right-side button of the mouse 215 or other pointer device, causes the GUI module 415 to display a pop-up menu with options as specified in the custom-designed code embedded within web pages; the pop-up menu may include one or more menu options, corresponding to the labels included in the code embedded within the web page HTML code, and, associated with each label, a URL specifying a link to a program adapted to perform a desired action corresponding to such menu option.

It is pointed out that the use of browser plug-ins is merely one possibility of implementing the illustrative embodiment; another possibility is to use applets downloaded and running at the client side, i.e. at the data processing apparatus 105 of the user. More generally, according to an embodiment of the present invention, at the data processing apparatus of the user, a (e.g., software) functionality is provided for, adapted to interpret custom-designed pieces of code, embedded within the HTML code of web pages, for displaying menu options in respect of objects included in web pages, not available in conventional browsers.

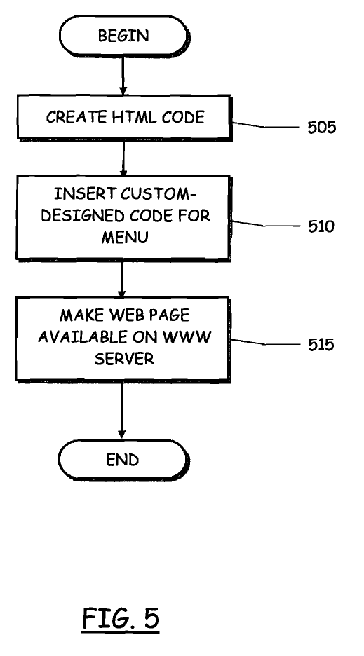

FIG. 5 is a schematic, simplified flowchart depicting the essential steps of a process for creating a web page including custom-designed code for rendering, at the side of the browser, a pop-up menu, e.g. in respect of a certain object or resource included in the web page. While writing as usual the HTML code of the web page to be then published on the WWW server 115 (block 505), the web page designer creates and includes the custom-designed code (block 510), which will be interpreted by, e.g., the plug-in 420 (more generally, the software functionality) of the browser, and that will allow the GUI 415 to display a pop-up menu, upon request of the user. For example, in one embodiment, the web page designer uses the MVC pattern, and the HTML code is generated by the view component 310, starting from dynamic data (the model 305), e.g. Java classes. For example, the dynamic data may include pairs of labels and corresponding URLs at which applications adapted to perform the actions corresponding to the labels are found. An example of a custom-defined piece of code that can be inserted into the HTML code of the web page for allowing rendering a pop-up menu at the browser side in respect of an object having a tree structure is:

<table border=“0” width=“100%” hastree=‘true’>

<treeroot>

<node label=“label-1” url=“url-action-1”>

</node>

<node label=“label-2” url=“url-action-2”>

</node>
. . .

</treeroot>

where <treeroot>, </treeroot> is an exemplary, custom-defined pair of HTML tags used to introduce a list of menu options to be displayed in a pop-up menu, and the tag pairs <node> and </node> are used to specify the items of the menu. Each “node” of the tree structure, i.e. each item of the menu to be displayed, includes a “label” attribute, and an “url” attribute. In the shown example, the “label” attribute of the first tree node is valued “label-1”, and the corresponding “url” attribute is valued “url-action-1”; the “label” attribute of the second tree node is valued “label-2”, and the corresponding “url” attribute is valued “url-action-2”; “label-1” and “label-2” are the labels that will be displayed by the browser in respect of the two menu items, whereas “url-action-1” and “url-action-2” are the links that will be activated upon selection by the user of either one of the two menu items for launching the application intended to perform the desired action. Examples of actions that can be performed are in general related to the nature of the object/resource embedded in the web page: for example, in the case of an object having a tree structure typical actions may be “expand all” or “collapse all”, for an object corresponding to a list of items, a possible action may be “select all” The exemplary attribute “hastree” in the <table> tag is used as a control for the instructing the plug-in 420 of the browser that a pop-up menu has to be rendered and displayed.

The web page, once generated, is made available, i.e. published on the WWW server 115 (block 515).

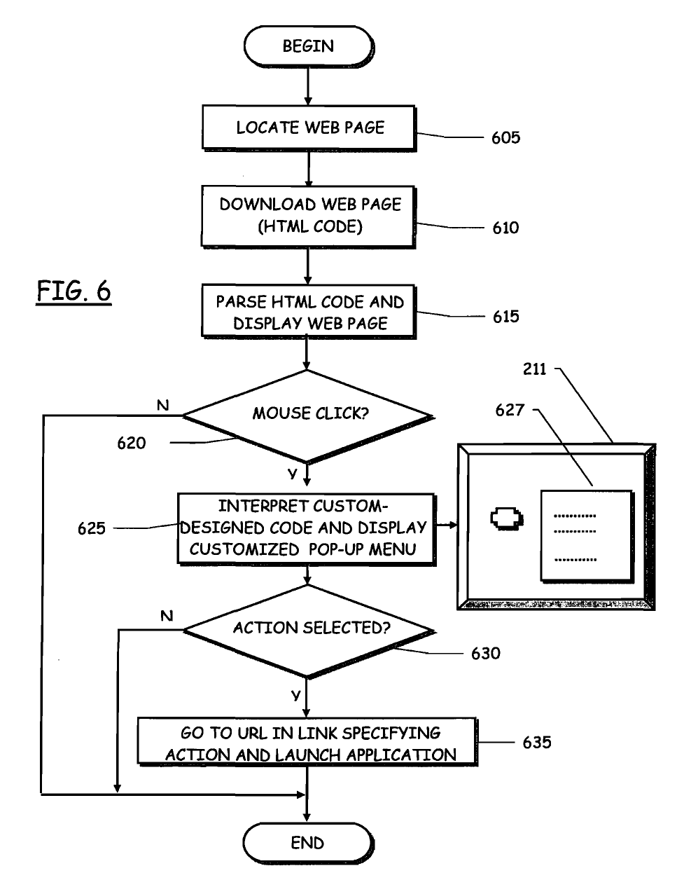

FIG. 6 is a schematic, simplified flowchart depicting the main actions performed by the browser running on the client data processing apparatus 105 for displaying a web page to the user of the data processing apparatus 105.

The user locates in the WWW a web page, e.g. by directly inputting the URL thereof in the browser, or getting there through hypertext links to the web page included in other pages (block 605). The (HTML code of the) located web page, for example made available by the WWW server 115, is downloaded to the data processing apparatus 105 (block 610). The HTML parser 410 of the browser parses the downloaded HTML code (block 615), and, through the GUI 415, the web page is displayed on the display device 211.

Let it be assumed that, while the web page is being displayed, the user positions the pointer in correspondence of an object embedded in the web page—for example a tree object and to which the web page designer has associated a custom menu; if the user clicks a button of the pointing device, e.g. the right-hand mouse button (block 620, exit branch Y), the browser plug-in 420 interprets the custom-designed code embedded in the web page HTML code and causes the GUI 415 to display the pop-up menu (block 625), with one or more menu items corresponding to actions that are offered to the user in respect of the embedded object. For example, referring back to the exemplary software code provided in the foregoing, the browser plug-in 420, ascertaining that the attribute “hastree” is set equal to “true”, understands that the object included in the web page has a tree structure, and that a pop-up menu is associated with said object, and displays a pop-up menu 627, with the menu items (menu options) displayed in the form of labels “label-1”, “label-2”, and so on.

The user, by means of the pointing device, can select one of the menu options, as he/she would normally do when navigating over the local file system of in respect of, e.g., image files, by positioning the pointer on the corresponding label and selecting it, e.g. by clicking the left-side mouse button (block 630, exit branch Y); in this case, the browser plug-in module 420 uses the URL associated with that label in the custom-designed code embedded within the web page HTML code as a link to locate and activate the application that is adapted to perform the desired action (block 635). For example, in the case of a tree object included in a web page, the actions that may be performed on it may be “expand tree”, “collapse tree”, “add element to tree”; in the case of an object being a list of items, an exemplary action that may be performed is “select all items in the list”.

It is pointed out that the URL that, in the custom-designed code embedded in the web page HTML code, is associated with a certain menu option label, can either be a generic web address (e.g., “go to www.ibmsupport.com”), or a link to an executable remote code on a server (e.g., it can perform a specific application action, such as actions described into examples above) to be invoked when action selected. In case, instead of a browser plug-in, an applet is exploited, the applet is already downloaded when the pop-up menu is presented, and it is the applet itself responsible of both showing the menu and contacting the URL when selected.

More generally, instead of a URL, actions may also be invoked that correspond to applications already available locally at the client, according to the security local setting related to the browser plug-in or applet.

Thanks to the aspects of the illustrative embodiments, the browser can display, e.g. in the form of a pop-up menu, options (e.g., commands) related to a generic object/resource included in a displayed web page and corresponding for example to a generic resource residing on the WWW server, even if the browser is not aware of either the nature of the object/resource, or of the action(s) that can be performed on it. This significantly improves the user experience, extending the paradigm of GUIs to which the users are accustomed.

1. A method of displaying web pages to a user, comprising:
receiving a web page to be displayed, wherein the web page comprises markup language code;
interpreting the markup language code,
identifying a markup language code element embedded in the markup language code of the web page to be displayed, wherein the markup language code element comprises an indication of at least one menu option to be displayed upon request of the user; and
responsive to a command from the user, displaying a pop-up menu containing said at least one menu option.

2. The method of claim 1, wherein the markup language code element comprises a label to be displayed in said pop-up menu for identifying said at least one menu option.

3. The method of claim 2, wherein the markup language code element further comprises a link to a software application adapted to perform an action corresponding to said label.

4. The method of claim 3, further comprising:
responsive to a selection by the user of the at least one menu option, invoking said software application exploiting said link.

5. The method of claim 1, wherein said command from the user is received through a pointing device.

6. The method of claim 1, wherein the markup language code element embedded in the markup language code of the web page to be displayed relates to an object having a tree structure, said at least one menu option including at least one of an expand tree option, a collapse tree option, or an add item to tree option.

7. The method of claim 1, wherein the markup language code element embedded in the markup language code of the web page to be displayed relates to an object corresponding to a list of elements, said at least one menu option including at least a select element in list option.

8. A data processing system, comprising
a processor; and
a memory coupled to the processor, wherein the memory comprises instructions which when executed by the processor, cause the processor to:
receive a web page to be displayed, wherein the web page comprises markup language code;
interpret the markup language code,
identifying a markup language code element embedded in the markup language code of the web page to be displayed, wherein the markup language code element comprises an indication of at least one menu option to be displayed upon request of the user, and
responsive to a command from the user, display a pop-up menu containing said at least one menu option.

9. A computer program product comprising a computer recordable medium having a computer readable program recorded thereon, wherein the computer readable program, when executed on a computing device, causes the computing device to:
receive a web page to be displayed, wherein the web page comprises markup language code;
interpret the markup language code,
identifying a markup language code element embedded in the markup language code of the web page to be displayed, wherein the markup language code element comprises an indication of at least one menu option to be displayed upon request of the user; and
responsive to a command from the user, display a pop-up menu containing said at least one menu option.

10. The data processing system of claim 8, wherein the markup language code element comprises a label to be displayed in said pop-up menu for identifying said at least one menu option.

11. The data processing system of claim 10, wherein the markup language code element further comprises a link to a software application adapted to perform an action corresponding to said label.

12. The data processing system of claim 11, wherein the instructions further cause the processor to:
responsive to a selection by the user of the at least one menu option, invoking said software application exploiting said link.

13. The data processing system of claim 8, wherein said command from the user is received through a pointing device.

14. The data processing system of claim 8, wherein the markup language code element embedded in the markup language code of the web page to be displayed relates to an object having a tree structure, said at least one menu option including at least one of an expand tree option, a collapse tree option, or an add item to tree option.

15. The data processing system of claim 8, wherein markup language code element embedded in the markup language code of the web page to be displayed relates to an object corresponding to a list of elements, said at least one menu option including at least a select element in list option.

16. The computer program product of claim 9, wherein the markup language code element comprises a label to be displayed in said pop-up menu for identifying said at least one menu option.

17. The computer program product of claim 16, wherein the markup language code element further comprises a link to a software application adapted to perform an action corresponding to said label.

18. The computer program product of claim 17, wherein the computer readable program further causes the computing device to:
responsive to a selection by the user of the at least one menu option, invoking said software application exploiting said link.

19. The computer program product of claim 9, wherein said command from the user is received through a pointing device.

20. The computer program product of claim 9, wherein the markup language code element embedded in the markup language code of the web page to be displayed relates to an object having a tree structure, said at least one menu option including at least one of an expand tree option, a collapse tree option, or an add item to tree option.
